(19) United States
(12) Patent Application Publication
(10) Pub. No.: US 2026/0161920 A1
(43) Pub. Date: Jun. 11, 2026

(54) RFID ANTENNA

(71) Applicant: Sato Holdings Corporation, Tokyo (JP)

(72) Inventors: Tai Wai Pong, St Peters (AU); Ganesh Nagendra, St Peters (AU); Graham Murdoch, St Peters (AU)

(73) Assignee: Sato Holdings Corporation, Tokyo (JP)

(21) Appl. No.: 18/704,268

(22) PCT Filed: Oct. 26, 2021
(86) PCT No.: PCT/IB2021/059849

§ 371 Date: Apr. 24, 2024

(51) Int. Cl. G06K 19/077; H01Q 1/22; H01Q 1/36; H01Q 7/00

(52) U.S. Cl. CPC G06K 19/0779; H01Q 1/2208; H01Q 1/36; H01Q 7/00

(57) ABSTRACT

An RFID antenna for a container having an electroconductive container component is described. The RFID antenna comprises an antenna body having a surface comprising at least a portion of the electroconductive container component. The antenna body is shaped to define an antenna volume for receiving one or more RFID tagged items, and the antenna body forms a single turn solenoid. The RFID antenna further comprises at least one current feed point and at least one current return point, the feed and return points electrically connected to the antenna body so that a current flowing through the antenna body generates a magnetic field within the antenna volume for reading RFID tags.

### TECHNICAL FIELD

The present disclosure relates, generally, to RFID readers, antennas and antenna systems and, more particularly, to an RFID antenna for a container having an electroconductive container component such as a metal wall.

### BACKGROUND

Vaccine fridges and freezers, particularly in third world or developing countries, are sometimes reliant on intermittent and unreliable power. Therefore, the fridges or freezers must be efficient and minimise temperature changes when the contents are accessed.

One type of vaccine fridge 100 is a ‘chest’ type design as shown in FIG. 1. Access to the vaccine fridge 100 is from the top 102 with a top opening lid 104 to access the stored contents of the fridge within various compartments 106 inside the fridge. This type of design provides good insulation and minimises loss of cold when the lid 104 is opened.

Radio-frequency identification (RFID) tracking of vaccines requires RFID reading of RFID tags in the fridge. Typically, the internal liner of the walls 108 of the fridge 100 are metal to efficiently conduct the heat out of the vaccine. Consequently, installing any type of RFID system is problematic as the metal walls 108 shield and cancel or reflect radio signals. Fitting RFID antenna shelving into the fridge (for example by inserting shelving that incorporates an antenna system) is relatively expensive, will reduce the available storage volume and requires complex electronics with a high power demand.

There is a need for a simple, low cost and reliable RFID antenna system that can be used with chest-type fridges and freezers so that RFID tags on items within the fridge or freezer can be read.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

In one aspect there is provided an RFID antenna for a container having an electroconductive container component, the RFID antenna comprising: an antenna body having a surface comprising at least a portion of the electroconductive container component.

The antenna body may be shaped to define an antenna volume for receiving one or more RFID tagged items. The antenna body may be shaped to form a hollow prism. The hollow prism may be one of: a hollow cuboid, a hollow cylinder, and a hollow polyhedral prism.

The antenna body may form a single turn solenoid. The antenna body may be unshielded within the container.

The RFID antenna may further comprise at least one current feed point and at least one current return point, the feed and return points electrically connected to the antenna body so that a current flowing through the antenna body generates a magnetic field within the antenna volume for reading RFID tags.

The antenna body may comprise an electric break so that the at least one current feed point provides current to the antenna body on a first side of the electric break, and the at least one current return point provides a current return path on a second opposite side of the break. The electric break may comprise a dielectric gap in the antenna body. The antenna body may have a first edge and a second edge, the first edge overlapping the second edge so that the electric break is formed in an overlapping region.

The antenna body may further comprise an electroconductive container compartment dividing component. The electroconductive container compartment dividing component may comprise a divider separating two adjacent RFID antennas. The dividing component may be affixed to the electroconductive container component via a dielectric element to form a capacitive component of the RFID antenna.

Each of the two adjacent RFID antennas may generate a magnetic field, the magnetic fields being in opposite directions so that a sum of the two magnetic fields is less than +42 dBuA/m at a distance of 10 m from the container.

In another aspect there is provided an antenna system comprising: a plurality of RFID antennas as described above; and an antenna controller configured to consecutively activate two adjacent RFID antennas at a time.

In another aspect there is provided a tripartite RFID label adapted to be applied to an item having at least three adjacent surfaces, each surface in a different plane, the RFID label comprising: a flexible antenna substrate having three adjacent regions configured relative to one another so that, when applied around a vertex of the three adjacent surfaces in three planes, each of the three adjacent regions is associated with one of the three adjacent surfaces; an RFID antenna positioned one each of the three adjacent regions, each RFID antenna connected to an RFID chip, wherein each RFID antenna, when activated, has a magnetic field perpendicular to a respective one of the substrate regions so that, in use when the RFID label is applied to the item, each antenna's magnetic field is perpendicular to a respective item surface.

Each RFID antenna may have its own RFID chip. Each RFID antenna may be connected to one shared RFID chip.

### BRIEF DESCRIPTION OF DRAWINGS

Embodiments of the disclosure are now described by way of example with reference to the accompanying drawings in which:

FIG. 1 is an example of a chest-type vaccine fridge.

FIG. 2A is an embodiment of a container having an RFID antenna configured for use with the container.

FIG. 2B shows the RFID antenna of FIG. 2A.

FIG. 3 is a schematic representation of a cylindrical embodiment of an RFID antenna.

FIG. 4A is a schematic representation of a cuboid embodiment of an RFID antenna.

FIG. 4B is a plan view of the RFID antenna of FIG. 4A.

FIG. 4C is a schematic representation of another cuboid embodiment of an RFID antenna.

FIG. 5A is a perspective view of a metal fridge liner of a vaccine fridge.

FIG. 5B is a schematic representation of a first embodiment an RFID antenna system comprising the metal fridge liner of FIG. 5A.

FIG. 6A is a perspective view of one embodiment of the RFID antenna system of FIG. 5B.

FIG. 6B is a perspective view of another embodiment of the RFID antenna system of FIG. 5B.

FIG. 7 is a schematic representation of an RFID antenna system having multiple RFID antennas.

FIG. 8A is a schematic representation of a second embodiment an RFID antenna system comprising the metal fridge liner of FIG. 5A.

FIG. 8B is an electric circuit model of the RFID antenna embodiment of FIG. 8A.

FIG. 8C is a simplified electric circuit model of the RFID antenna embodiment of FIG. 8A.

FIG. 8D is a perspective view of an example RFID antenna system according to the embodiment illustrated in FIG. 8A.

FIG. 9A is an electric circuit model of a multiple feed point embodiment.

FIG. 9B shows a circuit model of a feed point balancing transformer for the embodiment of FIG. 9A.

FIG. 10 shows an embodiment of an RFID antenna with multiple feed points.

FIG. 11 shows a schematic representation of an RFID reader for use with an RFID antenna.

FIG. 12A shows a plan view of a three-dimensional RFID tag for use with the RFID antennas described herein.

FIG. 12B illustrates the application of the three-dimensional RFID tag of FIG. 12A to a corner of an item.

FIG. 12C shows a prior art RFID tag.

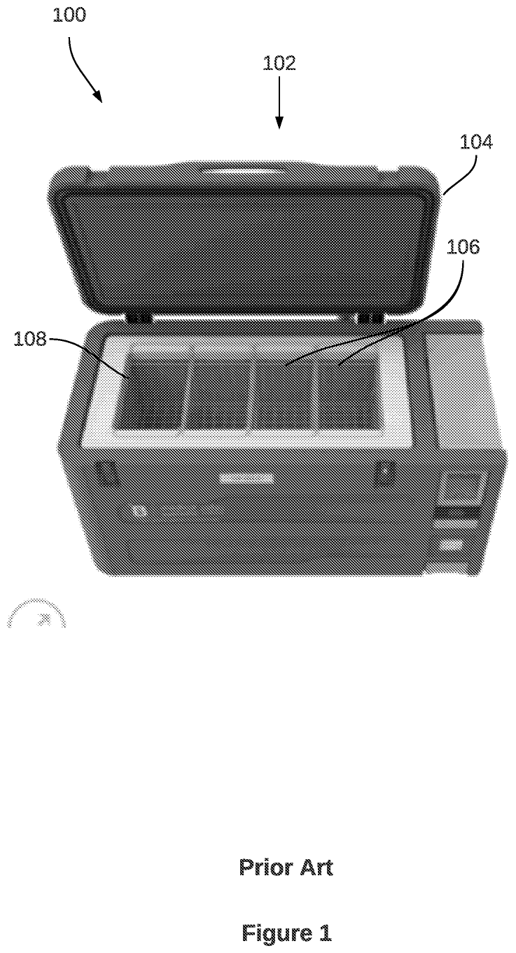

In the drawings, like reference numerals designate similar parts.

### DESCRIPTION

### Antenna System

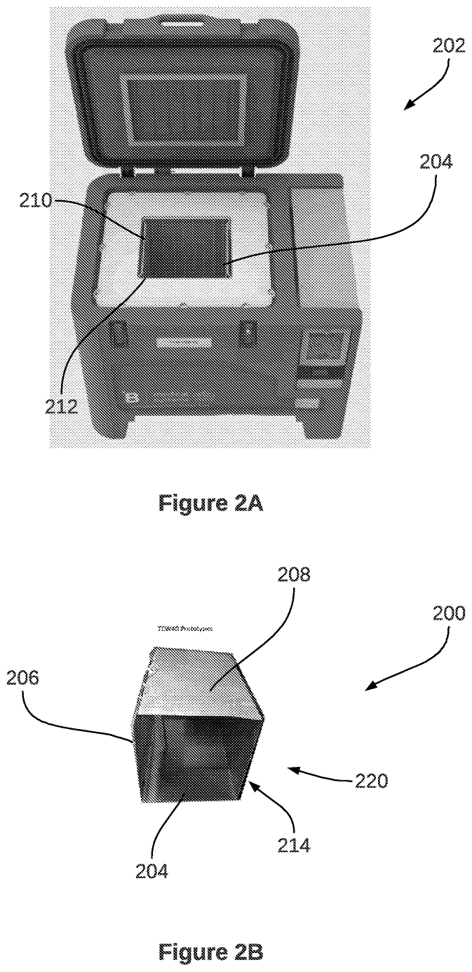

FIG. 2A of the drawings shows a container 202 (in this example a fridge or freezer, for example as used to store vaccines), the container 202 having an electroconductive container component 204. FIG. 2B of the drawings illustrates an RFID antenna 200 for the container 202, the RFID antenna 200 comprising an antenna body 206 having a continuous conducting surface 208 comprising at least a portion of the electroconductive container component 204.

In the fridge example, the electroconductive container component 204 is a metal liner 210 of the fridge compartment 212. The metal liner 210 lines the side walls of the compartment 212 and in this example is in the shape of a square tube, having four metal walls and no floor or ceiling. In this example, the antenna body 206 is unshielded within the container 202. In another example embodiment, the container is a cabinet having metal side walls and/or metal shelving; the metal walls and/or shelving of the cabinet are electroconductive container components that are incorporated into an RFID antenna system as described herein.

The antenna body 206 is shaped to define an antenna volume 214 for receiving one or more RFID tagged items, for example vaccine vials or boxes holding vaccine vials that are placed into the container 202.

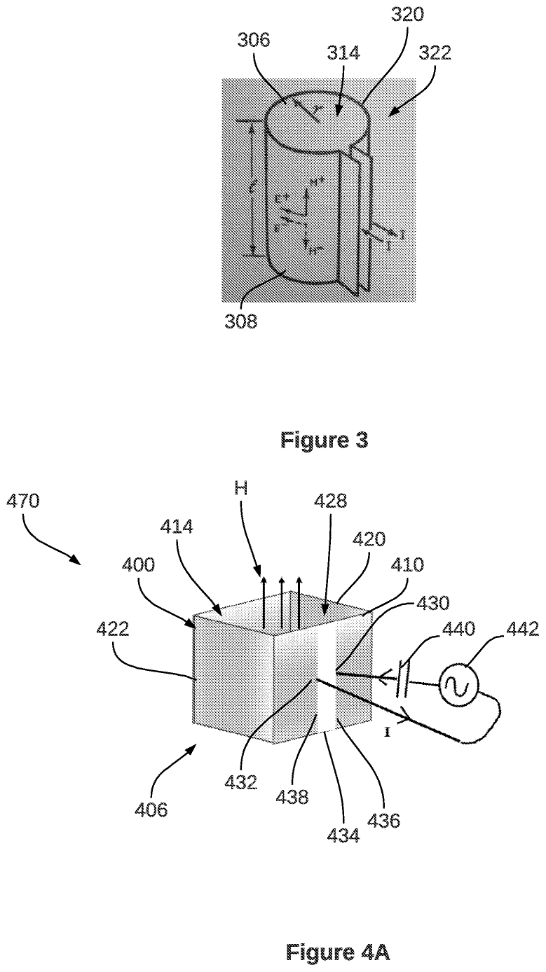

The antenna body 206 is shaped to form a hollow prism, for example the hollow cuboid 220 as shown in FIGS. 2A and 2B. The hollow prism can have any hollow cross-sectional shape, where the internal volume is used to hold items. The hollow prism has one or more walls with surface area, so that the hollow prism may be, for example, a hollow cylinder 320 as illustrated in FIG. 3 of the drawings or a hollow polyhedral prism.

Referring to FIG. 3, the antenna body forms a single turn solenoid 322 with an air core. Currents flowing on the metal surface 308 of the antenna body 306 form a current sheet which generates electromagnetic waves that propagate radially inwards and outwards from the two surfaces of the sheet. The inwards travelling wave sets up a standing wave inside the antenna volume 314, creating a uniformly distributed magnetic field, H.

In the embodiment where the antenna body 306 is in the form of the hollow cylinder 320 illustrated in FIG. 3, the inductance L of the solenoid 322 is given by L=μ₀A/l, where μ₀ is permeability of free space equal to 4π10⁻⁷, A is the area of the loop given by πr², and l is the length of the cylinder 320 (i.e. the longitudinal dimension perpendicular to the general direction of current flow).

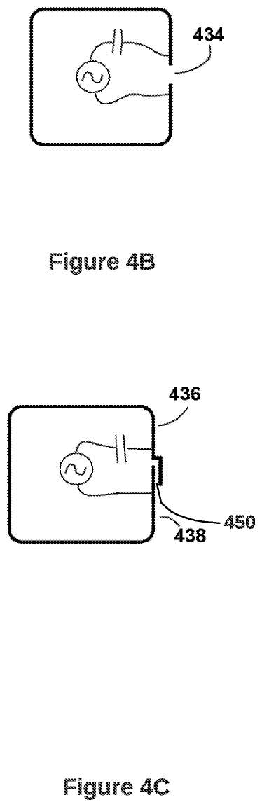

Referring to FIG. 4A of the drawings, an RFID antenna system 470 for monitoring a plurality of RFID tags in a container has an RFID antenna 400. Some embodiments (as described elsewhere herein) may include more than one RFID antenna, and each RFID antenna comprises an antenna body 406 formed by an electroconductive surface comprising at least a portion of an electroconductive component of the container. The RFID antenna 400 includes an electric gap 428 in the electroconductive surface, and at least one current feed point 430 and at least one current return point 432 on either side of the electric gap 428. The antenna body 406 is shaped to form a single turn solenoid defining an antenna volume 414 for holding RFID tagged items. The electroconductive surface is shaped and positioned on two of three dimensions, shown in FIG. 4A as side walls (with no floor or ceiling at the bottom or top of the body), so that the internal magnetic field can pass from the inside to the outside of the antenna body 406 to create the magnetic return path. Furthermore a conductive floor or ceiling at the tube ends and connected to the walls should be avoided as this would short the current sheet.

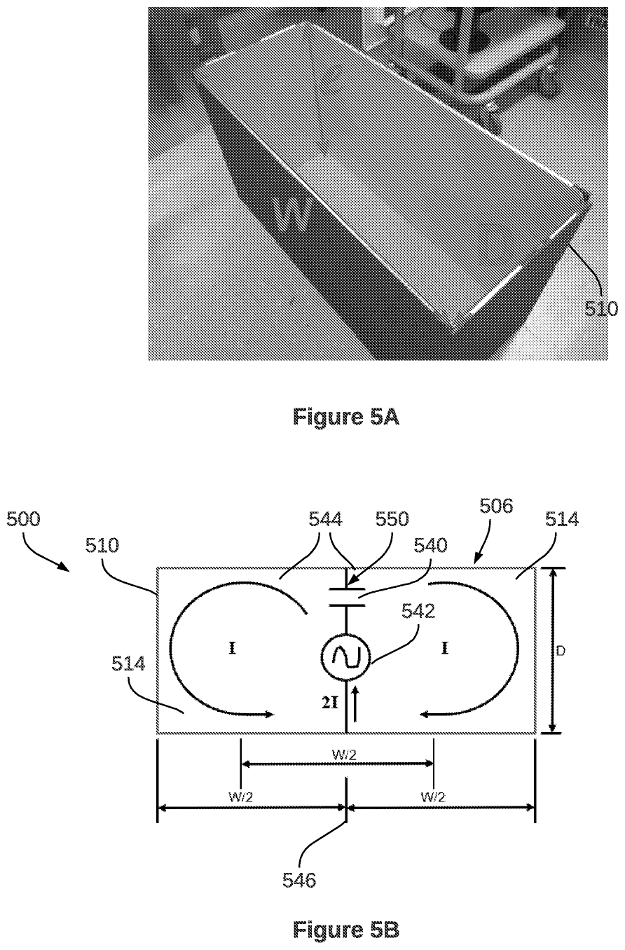

For the hollow (rectangular) cuboid 420 that forms the body 406 of the antenna 400, the area A is the width W multiplied by the depth D as shown in FIG. 5A. The inductance of the rectangular solenoid 422 is given by L=μ₀DW/l.

The internal magnetic field H is aligned along the axis of the solenoid 422 in the direction of l (being the longitudinal dimension perpendicular to the general direction of current flow) and is given by Amperes Law: H=I/l, where I is the total current flowing in the solenoid sheet.

For the example embodiment of the fridge, there are no metallic structures at either of the top or bottom of the liner making the inductance and magnetic field calculations for the vaccine fridge liners very accurate. The typical field required to operate an RFID tag is in the range 0.5 Å/m to 1.0 Å/m depending upon the tag size. A field strength of 2 Å/m is adequate for RFID interrogation of tags with poor orientations.

The dimensions, inductance, and field strength for two example models of vaccine fridges are shown in Table 1:

TABLE 1
Fridge liner mechanical and electrical parameters

| | | | | | | I for |
|---|---|---|---|---|---|---|
| Model | W | D | l | L | H (@ 1 A) | 2 A/m |
| Small | 0.357 m | 0.357 m | 0.47 m | 340 nH | 2.12 A/m | 0.943 |
| Large | 1.016 m | 0.41 m | 0.61 m | 858 nH | 1.639 A/m | 1.220 |

An RFID antenna is a conductive structure with terminals that connect to an RFID reader. The RFID reader controls operation of the RFID antenna (for example via an antenna controller), and receives information about RFID tags from the RFID antenna. The RFID reader provides a signal source to the RFID antenna to activate the RFID antenna in order to interrogate RFID tags.

Referring again to FIG. 4A of the drawings, the small fridge example has a metal liner 410 that is substantially square in cross section. The terminals of the RFID antenna 400 are a current feed point 430 and a current return point 432. The feed and return points 430, 432 are electrically connected to the antenna body 406 so that a current flowing through the antenna body 406 generates a magnetic field H within the antenna volume 414 for reading RFID tags.

The antenna body 406 has an electric break 434 so that the current feed point 430 provides current to the antenna body 406 on a first side 436 of the electric break 434, and the current return point 432 provides a current return path on a second opposite side 438 of the break 434. The electric break is formed by a longitudinal gap 428 in the antenna body, with air or another dielectric separating the two sides 436, 438 so that current can be applied to the antenna 400. The gap 428 may be small (for example 1 mm or less), provided that there is no electrical connection to short circuit the signal source applied across the gap. The gap may be larger (for example 5-20 mm), however if the gap is too large (for example a separation of more than 20 mm between the first side 436 of the electric break 434 and the second opposite side 438) then the magnetic field inside the antenna volume 414 may be compromised as the magnetic field H leaks out through the gap.

FIG. 4B is a plan view of the embodiment illustrated in FIG. 4A. As can be seen, the electric break 434 is in the form of a longitudinal gap 428. The smaller the gap 428 is, the less magnetic field leakage occurs.

Leakage through the electric break 434 can be eliminated by adjusting the form of longitudinal gap 428 such that there is an overlap of the two side 436 and 438 as shown in cross section in FIG. 4C. Where there is sufficient overlap, the magnetic field is forced to run parallel to the liner surface and cannot pass through the gap 428. An overlap width of five to twenty times (for example about ten times) the gap width results in a suitable containment for the magnetic field lines. For example, if the first side 436 overlaps the second side 438 with 10 mm, and there is a 1 mm separation 450 between the first side 436 and the second side 438 will, then there will be very little or substantially no leakage of the magnetic field from the gap. The method of implementing an overlap to prevent magnetic field leakage is described in WO2016038897, the contents of which are incorporated herein by reference.

For the fridge example embodiment, a simple method of creating the current sheet is to adapt the fridge liner wall, for example to cut the liner 410 and inject the current into the liner at the point of the cut (shown in FIG. 4A in the middle of one side wall but could also be at a corner between two walls, or anywhere around a cylinder as illustrated in FIG. 3). A tuning capacitance or capacitor(s) 440 can be connected in series with the signal source 442 to tune out the inductance of the liner loop.

### Multiple Compartments

For a larger container, there may be multiple areas, regions, or compartments in the container where RFID tagged items can be held and where an RFID antenna can be implemented for reading the RFID tags. FIG. 5A shows a rectangular metal liner 510 used for a larger fridge. The large rectangular shape lends itself to injection across the centre 546 of the liner 510 creating a Figure-8 antenna 500 with two counter rotating current loops 544.

The injected current I is divided between the two halves of the liner to create two counter rotating current loops 544 as shown. A tuning capacitor or tuning capacitor(s) 540 can be added in series with the signal source 542 to cancel out the inductance of the liner.

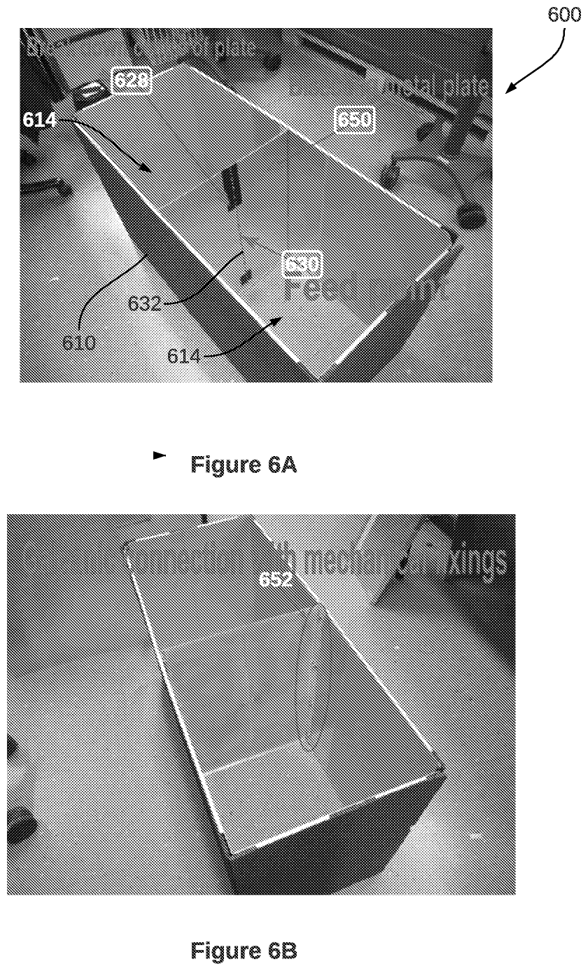

Referring to FIGS. 6A and 6B of the drawings, the larger fridge with a rectangular metal liner 610 uses a centre line injection in order to create Figure-8 counter circulating currents in two adjacent antennas within the liner 610. The internal metal liner 610 that forms part of the fridge is adapted to include an electroconductive container compartment dividing component. The electroconductive container compartment dividing component may include a divider separating two adjacent RFID antennas, for example in the form of a conductive dividing wall such as a central metal plate divider 650 that bisects the liner cavity creating two equal cavities that form antenna volumes 614. The feed point 630 and return point 632 for the radio frequency (RF) signal are on either side of a longitudinal gap 628 in the metal plate 650. The gap 628 may be positioned on the centre of the plate 650, or may be offset to either end of the plate if convenient. The feed and return points 630, 632 are positioned on a shared portion of the adjacent antenna bodies so that a single current injection means is shared by adjacent RFID antennas, the injected current splitting into two substantially equal parts to form two counter rotating current loops.

Referring to FIG. 6B, the connection between the divider 650 and the liner 610 can be made by direct galvanic connection 652. Direct galvanic connection can be made using metal to metal contact, for example via mounting screws, rivets, solder, etc.

The concept of a metal divider being used to deliver current to conductive liner walls can be extended beyond two half compartments to multiple compartments. Instead of one divider, multi-compartment embodiments have multiple dividers which create a number of equally or similar sized compartments.

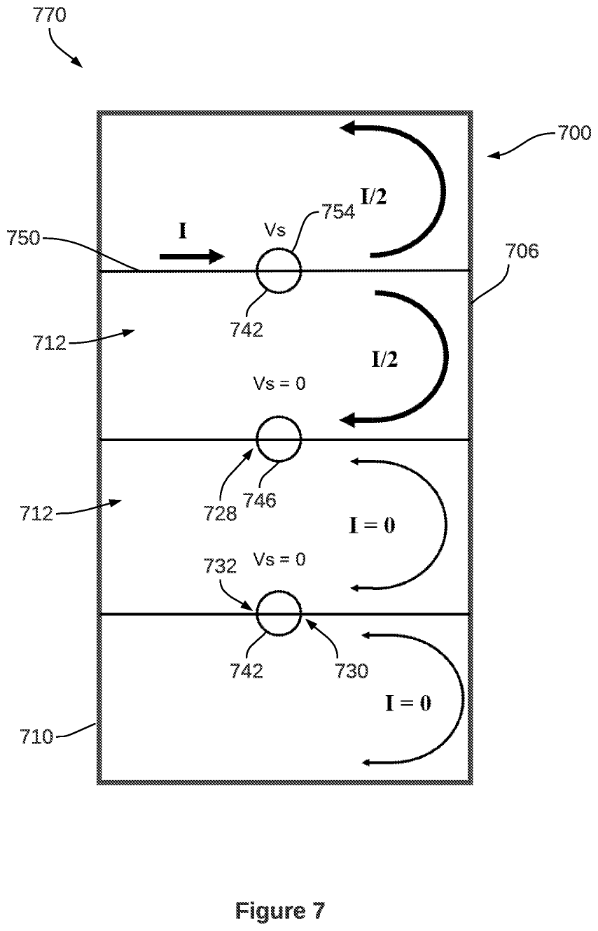

Referring to the antenna system 770 FIG. 7 of the drawings, each divider 750 has a signal source 742 which can be either a source injecting current I or a voltage source set to zero volts (in this example embodiment it is a centre driven signal source). The zero volts signal source 746 behaves as a short circuit shorting the two sides of the divider plate 750 on either side of the electric gap 728.

The sources 742 are individually (and in some embodiments sequentially and/or consecutively) switched so that one source at a time is activated to be the active source 754 and to scan the contents of its two adjacent compartments 712. By activating a series of sources 742, one at any given time, the RFID system scans through all the compartments 712 of a multi-compartment container. The antenna controller is configured to consecutively activate two adjacent RFID antennas at a time.

By setting only one source to be active and all other sources to be zero volts, the two compartments 712 adjacent to the active source 754 will behave like the two-compartment embodiment described elsewhere herein while all other compartments will be short circuited loops and have zero net magnetic field. In this way a large multiple compartment metal structure can be RFID enabled with a low cost one-dimensional system.

FIG. 7 shows an embodiment with four compartments, having three dividing walls and three sources. In an alternative four-compartment embodiment, the middle wall does not have a source, and so that the first source (in wall number one) enables reading of RFID tags within compartments one and two when activated, and the second source (in wall number three) enables reading of RFID tags within compartments three and four when activated.

Control of the signal sources and their impedances can be achieved by use of the principles described in international patent application WO2010/025516 (the contents of which are incorporated herein by reference) to control the source impedance ensuring a low short circuit impedance when Vs=0.

The RFID antenna system 770 comprises an electroconductive body 706 having one or more side walls defining a container volume, and one or more electroconductive dividing walls 750 that divide the container volume into compartments 712. Each dividing wall 750 comprises an electric gap 728 with a current feed point 730 and a current return point 732 on either side. The current feed point 730 comprises one or more current feed points, and the current return point 732 comprises two or more current return points. The electroconductive body 706 comprises at least a part of the metal liner 710 of the container, and each electroconductive dividing wall 750 comprises two wall portions on either side of the electric gap 728. Each electroconductive dividing wall 750 is affixed to the electroconductive body 706. In some embodiments, the electroconductive dividing wall is affixed to the electroconductive body via a capacitance plate and a dielectric spacer positioned between the capacitance plate and the electroconductive body as described elsewhere herein.

The RFID antenna system 770 includes a signal source per dividing wall. These signal sources are provided by an RFID reader, and may comprise one or more RFID reader antenna signal sources.

In some embodiments, the RFID antenna system 770 includes an antenna controller configured to activate one signal source at a time so that current flows through a portion of the electroconductive body and the dividing walls that surround and form the compartments that share an activated signal source. In other embodiments, the antenna controller is separate and/or external to the RFID antenna system 770.

### Capacitive Connection

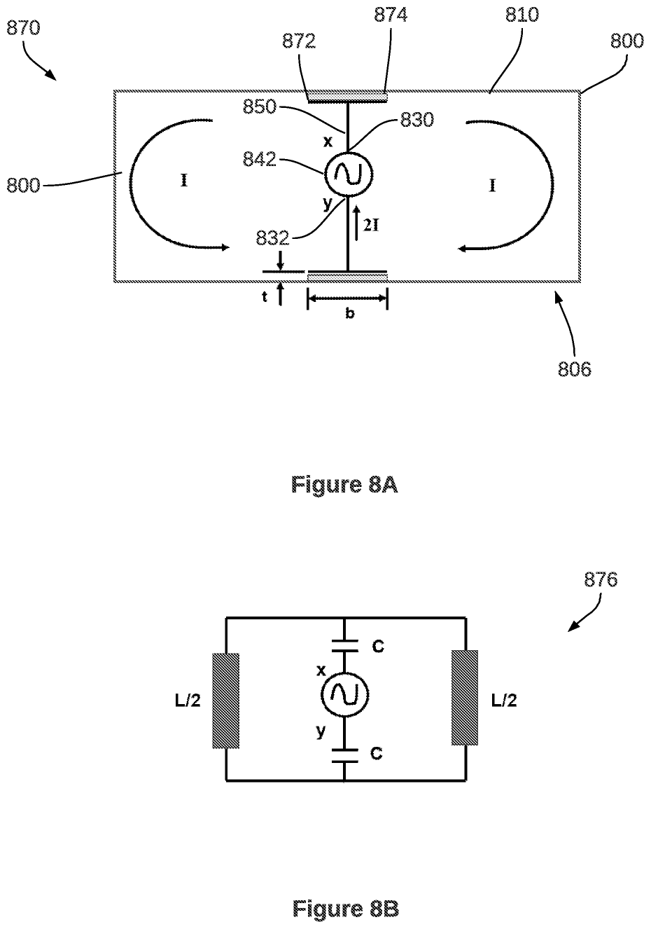

Direct galvanic connection between the liner and divider plate may not be possible. For example, the liner wall surface may not be conductive due to corrosion resistance treatments such as anodization, or the use of mechanical fixings may not be acceptable. In such cases, the dividing component may be affixed to the electroconductive container component via a dielectric element to form a capacitive component of the RFID antenna. The capacitive connection between the metal plate divider and the liner can be used as illustrated in FIGS. 8A-8D of the drawings.

The circuit model for an antenna system 870 having two antennas 800 and incorporating capacitive plates 872 is shown in FIG. 8A. Each plate 872 has a width of b and a height of l (being the longitudinal dimension of the antenna body 806 perpendicular to the general direction of current flow). A dielectric spacer 874 is used. The spacer 874 may be the insulation layer formed by an anodization or it may be a spacer (for example a plastic spacer) of a pre-defined thickness t chosen to give a particular capacitance between the plate 872 and the liner 810.

The capacitance Cₚ of the plate is given by Cₚ=ε₀εᵣbl/t, where ε₀ is the permittivity of free space and εᵣ is the relative dielectric constant which is typically 2.2 for non-polar plastics. The dielectric spacer 874, having a small thickness, has a relatively large capacitance and acts as an RF short circuit. In this case a separate series tuning capacitance may be used to tune out the inductance of the liner loops. Alternatively, the thickness of the spacer and the size of the capacitive plates can be chosen to provide the correct tuning capacitance.

Table 2 shows the capacitance of a metal plate with an adhesive glue layer of 50 um or a plastic spacer of 1 mm. For the glue layer the capacitance is so large as to serve as an acceptable RF short circuit, whereas for the 1 mm spacer the capacitance can serve as a part of the tuning capacitance.

TABLE 2
Capacitance of metal plate for different dielectric thicknesses

| | Capacitance 0.05 | Capacitance 1 |
|---|---|---|
| Metal Plate Size | mm glue gap | mm Plastic |
| 108 mm × 610 mm | 11.595 nF | 1.284 nF |

FIG. 8A shows a plan view of two-compartment antenna system with capacitive plates 872 coupling the centre metal divider 850 to the liner walls. FIG. 8B shows an electrical circuit model 876 for this arrangement, and FIG. 8C shows a simplified electrical circuit model 878. The capacitance C is the plate capacitance, and the inductance L is the inductance of the liner 850 as shown in Table 1.

The current feed point 830 and current return point 832 are on either side of the signal source 842.

Table 3 presents the example circuit model parameters showing that a plate width of 108 mm with a 1 mm plastic spacer at each end of the divider plate provides the correct tuning capacitance for the divider plate circuit.

TABLE 3
Divider plate circuit parameter values

| | | | | | Plate |
|---|---|---|---|---|---|
| | | | Tuning | Plate | width 1 mm |
| Model | L/2 | L/4 | capacitance | capacitance | plastic spacer |
| Large | 429 nH | 215 nH | 642 pF | 1.284 nF | 108 mm |

FIG. 8D is a perspective view of an example RFID antenna system 870 according to the embodiment illustrated in FIG. 8A. The metal divider 850 has a longitudinal flange 871 on either side, the longitudinal flange shaped to form a capacitive plate 872. In this example embodiment the divider 850 is affixed to the liner 810 via an adhesive glue layer such as a spray on contact such as Selleys Kwik Grip Spray Contact Adhesive applied between the flange and the central region of opposing side walls of the liner 810.

### Electromagnetic Compatibility (EMC) Compliance

There are two types of electromagnetic radiation. For near field radiation the distance between the source and the receiver is less than the wavelength of the emitted radiation divided by 2π, and for the far field the distance between the source and receiver is greater than the wavelength of the emitted radiation divided by 2π.

The current loop formed by the liner radiates in the far field. The far field radiation is dependent upon the area of the liner loop and the current in the loop. There is a maximum allowable far field strength for EMC compliance, for example in Australia the maximum far field radiation is +42 dBuA/m (126 uA/m) measured at a distance of 10 m. The equation that calculates the far field strength is given by H=IπDW/rλ², where λ is the wavelength of the RFID frequency. The RFID frequency for a high frequency (HF) system is 13.56 MHz with a wavelength of 22.124 m. The far field radiation strength for the two example models of vaccine fridges is tabulated in Table 4.

TABLE 4
EMC far field radiation values

| | I for | H @ | H @ | |
|---|---|---|---|---|
| Model | 2 A/m | 10 m | 10 m | Margin |
| Small | 0.943 | 77.14 uA/m | 37.74 dBuA/m | −4.25 dB |
| Large | 1.220 | 357.8 uA/m | 51 07 dBuA/m | +9.07 dB |

The small model meets the EMC compliance target while maintaining an internal field adequate for interrogating RFID tags (i.e., a field strength between about 0.5 Å/m and 2 Å/m as described elsewhere herein with reference to Table 1).

The large model does not meet the EMC compliance target and a modification is required to meet the EMC compliance while at the same time maintaining an internal field adequate for interrogating RFID tags.

Referring again to FIG. 5B of the drawings, where the large rectangular liner 510 is divided into two adjacent antenna volumes 514, the two counter rotating current loops 544 create two equal or substantially similar magnetic fields that cancel one another in the far field.

The far field radiation is the sum of the radiation from the individual counter rotating currents. The centres of the magnetic moment of each current loop are separated by half of the total width of the antenna body 506 (W/2). The far field is reduced as the fields subtract from each other. The equation that calculates the far field strength for the pair of counter rotating currents is given by: H=IπDW((r−W/4)⁻¹−(r+W/4)⁻¹))/2λ².

The far field radiation strength for the large size vaccine fridge antenna 500 with a centred source 542 is tabulated in Table 5. In this example embodiment the feed current is doubled in order to maintain the same current in the current sheet circulating in the liner.

TABLE 5
Far field radiation with centre feed

| | I for | H @ | H @ | |
|---|---|---|---|---|
| Size | 2 A/m | 10 m | 10 m | Margin |
| Large | 1.220 | 8.29 uA/m | 18.37 dBuA/m | −23.63 dB |

Each of the two adjacent RFID antennas generates a magnetic field, the magnetic fields being in opposite directions so that a sum of the two magnetic fields is less than +42 dBuA/m at a distance of 10 m from the container. In the example, the sum of the two magnetic fields is less than +19 dBuA/m. In this way, with centred current injection via the dividing component 550, the far field radiation is able to meet the EMC compliance targets.

The RFID antenna 500, adapted to be used with a container such as a fridge, has a body 506 defining at least first and second antenna volumes 514, two opposing sides of each of the antenna volumes being unshielded. The first antenna volume is defined by at least a first electroconductive component configured to generate a first magnetic field within the first antenna volume, the first magnetic field directed in a first direction. The second antenna volume is defined by at least a second electroconductive component configured to generate a second magnetic field within the second antenna volume, the second magnetic field directed in a second direction. The sum of the first magnetic field and the second magnetic field is less than +42 dBuA/m at a distance of 10 m from the container. In some embodiments, the sum is substantially zero outside the container. In some embodiments the first and second electroconductive components may be first and second portions of the same electroconductive body, for example a first half and a second half of a metal liner of a fridge (or a first shelf and a second shelf of a metal-shelved cabinet).

### Current Injection

Accuracy of the circuit model referred to herein requires some uniformity of the current sheet through the body of the RFID antenna. Injecting at one central point risks “crowding” the current leading to a non-uniform field distribution.

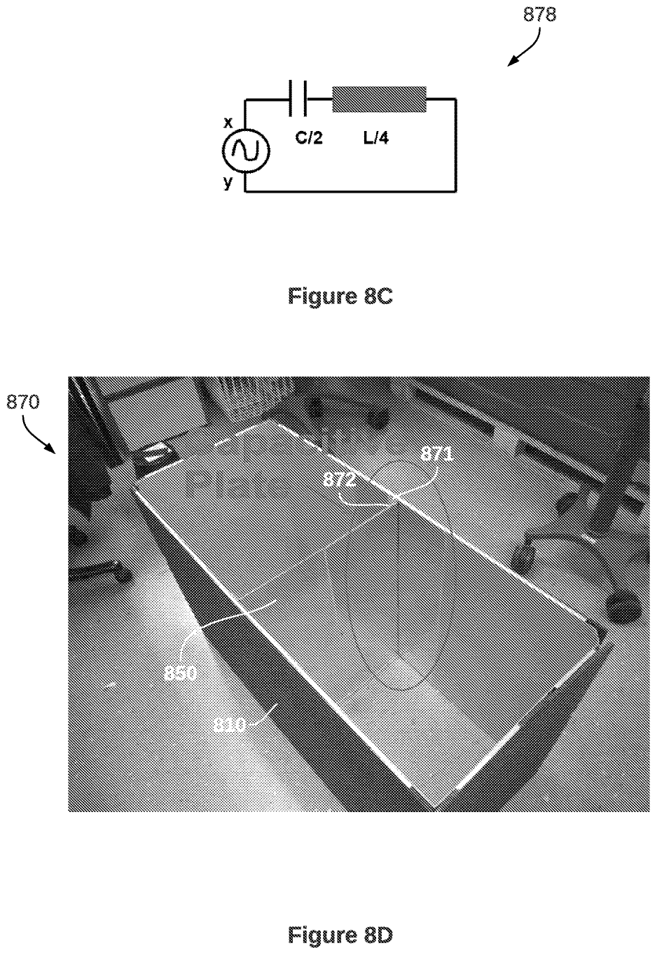

Injecting the current at multiple points across the divider plate using a current balancing circuit 980 provides a more uniform current distribution. This arrangement is shown with power splitters 982 in FIG. 9A of the drawings. One method of implementing multiple current injection points is described in WO2016121130, the contents of which are incorporated herein by reference.

In the example embodiment, each terminal (Feed0, Feed1, Feed2, and Feed3) is provided from a transformer 984 (as illustrated in in FIG. 9B) in order to provide a balanced differential current at each side of the divider plate. The drive points x and y, which are the current feed point 930 and the current return point 932, are equivalent to the current feed point 830 and the current return point 832 shown in FIG. 8A.

The transformer 984 can also be used for impedance transformation to adjust the drive point impedance and/or current magnitude.

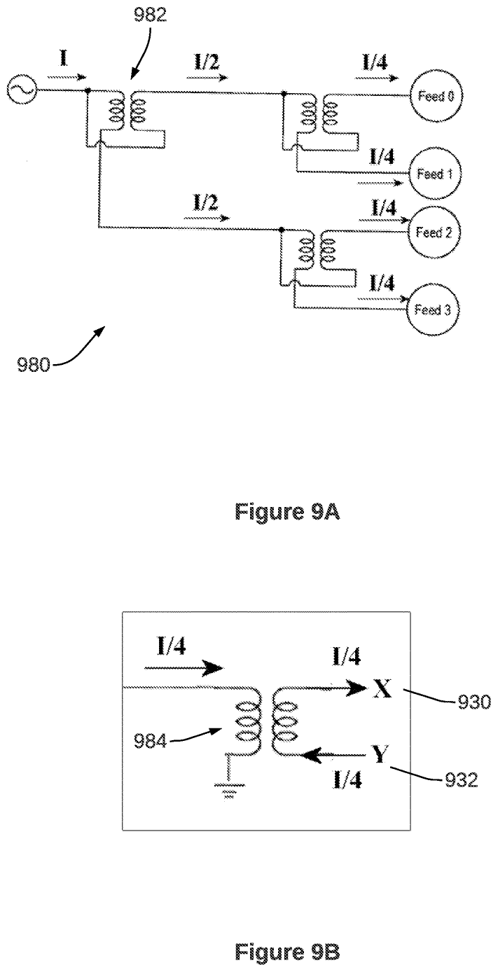

An example embodiment of an RFID antenna 1000 is shown in FIG. 10, the RFID antenna adapted for use in a container. The RFID antenna 1000 has a body 1006 formed by an electroconductive surface 1008 having a first edge 1036 and an opposite second edge 1038, the conductive surface 1008 shaped so that the first edge 1036 is positioned substantially adjacent the second edge 1038 so that the body 1006 defines a volume 1014 for receiving one or more RFID tagged items. The second edge 1038 is separated from the first edge 1036 by an electric gap 1028. The antenna 1000 has two or more current feed points 1030 at the first edge 1036 for supplying current to the antenna body 1006, and two or more current return points 1032 at the second edge 1038 for providing a return current path from the antenna body 1006. The conductive surface 1008 comprises at least a portion of an electroconductive region of the container, for example the inner metal liner 1010 of a fridge.

In some embodiments the position of the current feed points is aligned with the position of the current return points so that the current feed and return points lie substantially adjacent to one another. This is illustrated in FIG. 4A, for example. In other embodiments the position of the current return points is offset from the position of the current feed points so that a straight line from a current feed point to its closest current return point is not the shortest distance from the first edge 1036 to the second edge 1038. This is illustrated in FIG. 10 and may be done for mechanical or structural convenience.

### RFID Monitoring System

In some embodiments, the RFID antenna as described herein is provided as a separate device for integration into a container or already integrated into a container and incorporating the container's electroconductive component. For example, a fridge (such as a chest-type vaccine fridge) may have an inner metal liner adapted to function as an RFID antenna by having terminals provided on either side of an electric break in the liner or an electric break in a dividing wall positioned within the liner. In such embodiments, the container is adapted so that the terminals of the antenna can interface with a separate and external RFID reader, for example via an RF cable such as a coaxial cable, which connects between the RFID antenna and the reader's antenna interface.

In some embodiments, the RFID antenna system has one or more RFID antennas as described herein, and also an antenna controller. The antenna controller controls operation of the RFID antenna(s), for example the antenna controller may be configured to consecutively activate two adjacent RFID antennas at a time as described elsewhere herein.

In some embodiments, the RFID reader is provided in, next to, connected to, or in some other way associated with the container, the RFID reader being electrically connected to the RFID antenna via the antenna terminals.

In these embodiments, an RFID monitoring system (for monitoring a plurality of RFID tags in a container such as a fridge) has an RFID reader and at least one antenna for transmitting and receiving RF signals to communicate with the RFID tags. The at least one antenna is in communication with the RFID reader. As described herein, the at least one antenna comprises at least a portion of an electroconductive perimeter of the container. The portion of the electroconductive perimeter has a first edge and an opposite second edge, and the portion of the electroconductive perimeter is shaped so that the first edge is substantially adjacent and spaced from the second edge. The first edge is spaced from the second edge forming an electric gap between the first edge and the second edge. The electric gap may include a dielectric.

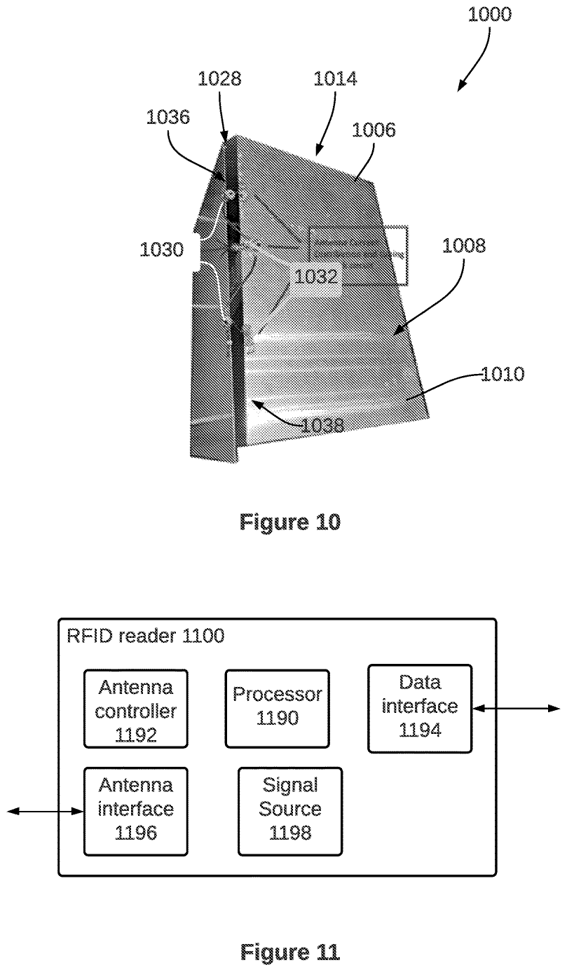

FIG. 11 of the drawings is a schematic representation of an RFID reader 1100 used with the antennas described herein. The RFID reader 1100 includes a processor 1190, an antenna controller 1192, a data interface 1194, an antenna interface 1196, and a signal source 1198. The processor 1190 is configured to cause the antenna controller to control operation of the RFID antenna, for example to provide power and activate one or more RFID antennas. The processor 1190 is configured to receive RFID tag information from the RFID antenna via the antenna interface 1196. The processor 1190 is configured to process the received RFID tag information and to cause transmission of the processed RFID tag information via the data interface 1194. The processor may be in the form of a microcontroller, for example an Atmel AT91RM9200-CI. The antenna controller 1192 may be implemented as part of the processor 1190, and/or via the same microcontroller. Alternatively, the antenna controller may be implemented using a programmable gate array. The antenna interface 1196 makes the electrical connection to the RFID antenna with the RF cable connecting to the RFID antenna, and also provides the signal source to the signal feed and return points using RF switches such as PIN diodes or RF relays for directing the signal from the signal source, as directed by the antenna controller 1192 under the control of the processor 1190.

For the example of an RFID system adapted for use with a chest-type fridge, in one embodiment the RFID reader may be fitted inside the compressor and controller compartment of the fridge. In another embodiment, the reader is connected to the antenna with a coaxial cable. The fridge has an interface to control the reader and trigger a read of the tags, for example a user interface (such as a button and/or screen), or a data interface configured to receive a read command. In some embodiments the fridge may include a GSM and/or GPS module configured to transmit data such as the fridge location, temperature, and RFID tag information to a server every day or several times a day. In some embodiments the RFID tag information is associated with tagged items by the processor 1190 of the RFID reader 1100. In other embodiments, the RFID tag information is associated with tagged items by the server that receives the information from the fridge.

### Three-Dimensional RFID Tag

Described herein is an RFID antenna comprising an antenna body having a surface comprising at least a portion of a container component, the container component being or including, for example, a metal liner of the container. The antenna body has an antenna terminal configured to provide at least one current feed point and at least one current return point to the antenna body. The surface of the antenna body is shaped to define at least one volume for holding one or more RFID tagged items.

The internal magnetic field H within the volume of the antenna body is a one-dimensional field being aligned along the axis of the solenoid and requires RFID tagged items that will function with a one-dimensional field. This means the tagged items should ideally be placed correctly to ensure that the tags are oriented to couple to the field correctly (for example stacked in a box or carrier with a defined and fixed orientation).

Embodiments described herein relate to the use of passive RFID tags. However, the technology described herein is equally applicable to active RFID tags.

In some embodiments, if the placement of the tagged items cannot be guaranteed, then one solution is to utilise more than one RFID tag, each tag having a different orientation. For example, an RFID tag may be placed on the lid of a bottle, and another RFID tag may be placed on a side wall of a bottle, thereby ensuring that at least two axes include RFID tags to increase the probability of being detected by the one-dimensional magnetic field inside the body of the RFID antenna.

For the example of a vaccine fridge holding vaccine vials, the vials may be placed within a box, and then the RFID tag(s) can be positioned on the box. In one embodiment, three RFID tags are placed on the box in order to have a tag on the X-, Y- and Z-axis faces of the box, thereby providing a tag for each dimension. Advantageously, the extra cost of tagging the box is only two extra tags. In contrast, tagging each vial would require significantly more tags, and where the vials are not positioned within a box to ensure the correct orientation, the result would likely not be that all tag would be readable within the single dimension of the magnetic field. The box tagging allows positive verification that the box of vials is in the fridge.

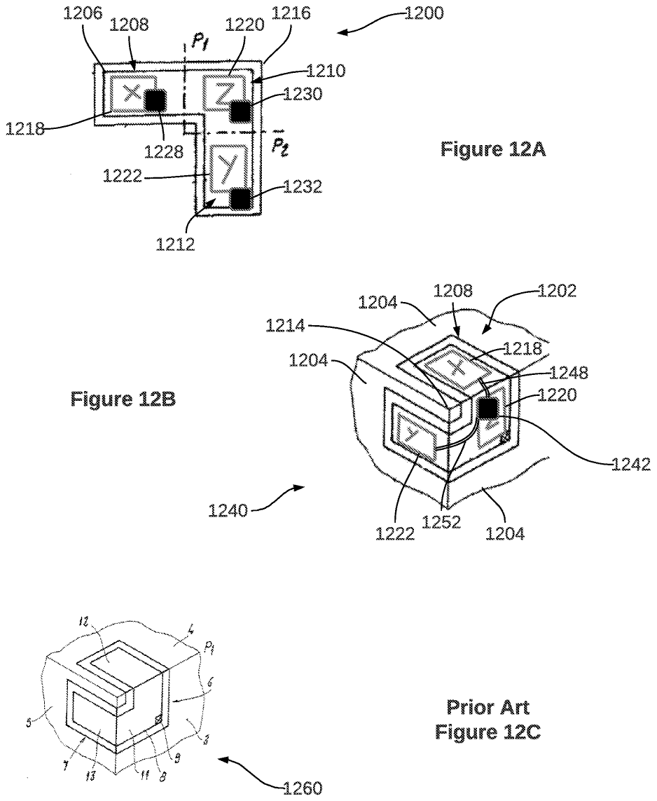

In other embodiments, an RFID label configured to operate in three dimensions may be applied to the item(s) located within the RFID antenna volume. A first embodiment of such a tripartite RFID label 1200 is illustrated in FIG. 12A of the drawings. The tripartite RFID label 1202 is adapted to be applied to an item 1202 having at least three adjacent surfaces 1204, each surface in a different plane (for example aligning with an X-, Y- and Z-axis when the surfaces are at right angles to one another as is the case for a typically square or rectangular box). The RFID label has a flexible antenna substrate 1206 having three adjacent regions 1208, 1210, 1212 configured relative to one another so that, when applied around a vertex 1214 of the three adjacent surfaces 1204 in three planes, each of the three adjacent regions is associated with one of the three adjacent surfaces 1204. The flexible substrate 1206 may be any suitable dielectric or non-conductive material that is flexible, and adapted to the purpose of application to an item, for example a flexible plastic. In the illustrated embodiment, the RFID label includes an adhesive underside 1216 for adhering the label to an item.

The tripartite RFID label 1202 has an RFID antenna 1218, 1220, 1222 positioned on each of the three adjacent regions 1208, 1210, 1212, each RFID antenna connected to an RFID chip 1228, 1230, 1232.

The shape and configuration of the tripartite RFID label 1200 is such that each RFID antenna 1218, 1220, 1222, when activated, has a magnetic field perpendicular to a respective one of the substrate regions 1208, 1210, 1212 so that, in use when the RFID label 1200 is applied to the item 1202, each antenna's magnetic field is perpendicular to a respective item surface. In this way, if (for example) a conventional holder, i.e. a box with orthogonal sides, has a label 1200 applied around one of its corners, then each antenna will lie in a different one of three orthogonal planes. Consequently, irrespective of orientation in which the holder is placed within the container described herein (e.g. a fridge or freezer such as those used to hold vaccines), there will be at least one antenna with an orientation such that said antenna is sufficiently aligned with the magnetic field generated by the RFID antenna of the container to operate.

In the embodiment of the tripartite RFID label 1200 in FIG. 12A, each RFID antenna 1218, 1220, 1222 has its own respective RFID chip 1228, 1230, 1232. Upon manufacture or initialisation of the RFID label, the three RFID chips 1228, 1230, 1232 are associated with one another so that a label read by an RFID reader that picks up any one of the chips, will associated that read with the one shared RFID label 1200.

Having all three individual antennas on the same L-shaped label provides a simple and reliable RFID label, so that three separate RFID tags can easily be applied via the same shared RFID label and substrate.

FIG. 12B of the drawings illustrates an alternative embodiment of a tripartite RFID label 1240. In this embodiment, each RFID antenna 1218, 1220, 1222 is connected to one shared RFID chip 1242, for example via a pair of antenna leads 1248, 1252. In this embodiment the single chip is associated with all three antennas, reducing the complexity of managing the information associated with the label 1240.

FIG. 12C illustrates a prior art embodiment of a label shaped to be applied around the corner of a box. However, as the label 6 includes a single antenna 8, with the antenna conductor looping around the edge of the label on all three sides 3, 4, 5 of the box, this configuration will not work because there is a field direction where the net field in the coil is zero. The arrangement of FIG. 12C behaves no different to a simple coil and is unsuited for 3D operation.

Described herein is a cost-effective method of fitting a simple and reliable RFID antenna to a container such as a metal-walled cabinet, or a chest fridge without the RFID antenna being adversely affected by the cabinet walls or the fridge liner's metal internal walls.

Advantageously, for the chest fridge embodiments, the RFID antenna design can be implemented without changing the design of the fridge as the metal liner of the fridge is used as part of the RFID antenna.

The internal metal liner that forms the refrigeration cavity of a chest style fridge forms a thermally conductive layer to remove heat from the internal cavity to the cooling system mounted behind and outside the metal liner walls. The antenna system described herein uses the internal metal liner of the fridge/freezer as part of the excitation loop (i.e. the antenna coil) to generate the magnetic field for reading RFID tags associated with items held in the fridge/freezer.

The liner is made of aluminium sheet and is a good screen and shield against radio waves. For the multi-compartment fridges, the liner forms a large rectangular electrically short metal tube. The small bucket style fridges have a similar liner design with the liner being a smaller square or rectangular tube. Rather than being impeded by the electrical properties of the liner, the RFID antenna system described herein puts the metallic conductivity of the liner to good use to conduct the RFID signal used for reading RFID tagged items inside the fridge.

Advantageously, the solution described herein works across a full range of vaccine fridge sizes, from the smallest bucket sized units to large chest fridges or freezers.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An RFID antenna for a container having an electroconductive container component, the RFID antenna comprising:
an antenna body having a surface comprising at least a portion of the electroconductive container component,
wherein the antenna body is shaped to define an antenna volume for receiving one or more RFID tagged items.

2. (canceled)

3. The RFID antenna of claim 1, wherein the antenna body is shaped to form a hollow prism.

4. The RFID antenna of claim 3, wherein the hollow prism is one of: a hollow cuboid, a hollow cylinder, and a hollow polyhedral prism.

5. The RFID antenna of claim 1, wherein the antenna body forms a single turn solenoid.

6. The RFID antenna of claim 1 wherein the antenna body is unshielded within the container.

7. The RFID antenna of claim 1, further comprising at least one current feed point and at least one current return point, the feed and return points electrically connected to the antenna body so that a current flowing through the antenna body generates a magnetic field within the antenna volume for reading RFID tags.

8. The RFID antenna of claim 7, wherein the antenna body comprises an electric break so that the at least one current feed point provides current to the antenna body on a first side of the electric break, and the at least one current return point provides a current return path on a second opposite side of the break.

9. The RFID antenna of claim 8, wherein the electric break comprises a dielectric gap in the antenna body.

10. The RFID antenna of claim 8, wherein the antenna body has a first edge and a second edge, the first edge overlapping the second edge so that the electric break is formed in an overlapping region.

11. The RFID antenna of claim 1, wherein the antenna body further comprises an electroconductive container compartment dividing component.

12. The RFID antenna of claim 11, wherein the electroconductive container compartment dividing component comprises a divider separating two adjacent RFID antennas.

13. The RFID antenna of claim 12, wherein the dividing component is affixed to the electroconductive container component via a dielectric element to form a capacitive component of the RFID antenna.

14. The RFID antenna of claim 12, wherein each of the two adjacent RFID antennas generates a magnetic field, the magnetic fields being in opposite directions so that a sum of the two magnetic fields is less than +42 dBuA/m at a distance of 10 m from the container.

15. An antenna system comprising:
a plurality of RFID antennas according to claim 1; and
an antenna controller configured to consecutively activate two adjacent RFID antennas at a time.

16. A tripartite RFID label adapted to be applied to an item having at least three adjacent surfaces, each surface in a different plane, the RFID label comprising:
a flexible antenna substrate having three adjacent regions configured relative to one another so that, when applied around a vertex of the three adjacent surfaces in three planes, each of the three adjacent regions is associated with one of the three adjacent surfaces;
an RFID antenna positioned one each of the three adjacent regions, each RFID antenna connected to an RFID chip,
wherein each RFID antenna, when activated, has a magnetic field perpendicular to a respective one of the substrate regions so that, in use when the RFID label is applied to the item, each antenna's magnetic field is perpendicular to a respective item surface.

17. The RFID label of claim 16, wherein each RFID antenna has its own RFID chip.

18. The RFID label of claim 16, wherein each RFID antenna is connected to one shared RFID chip.
